(19) United States
(12) Patent Application Publication
(10) Pub. No.: US 2026/0219378 A1
(43) Pub. Date: Jul. 30, 2026

(54) STATE DETECTION SYSTEM, DETECTION DEVICE, STATE DETECTION METHOD AND STATE DETECTION PROGRAM

(71) Applicant: NTT, Inc., Tokyo (JP)

(72) Inventors: Keita KURIYAMA, Musashino-shi, Tokyo (JP); Toshifumi MIYAGI, Musashino-shi, Tokyo (JP)

(73) Assignee: NTT, Inc., Tokyo (JP)

(21) Appl. No.: 19/143,404

(22) PCT Filed: Jan. 10, 2023
(86) PCT No.: PCT/JP2023/000339

§ 371 Date: Jun. 26, 2025

(51) Int. Cl. G01S 13/56; G01S 7/00

(52) U.S. Cl. CPC G01S 13/56; G01S 7/006

(57) ABSTRACT

A state detection system according to one embodiment is a state detection system including: a transmission device that transmits a predetermined signal; and a detection device, wherein the detection device includes: a receiver to receive, via the propagation path, signals of a same sequence repeatedly transmitted at a predetermined period by the transmission device; block division circuitry configured to divide the signals received by the receiver into blocks in units of the period; time correlation calculation circuitry configured to calculate a time correlation between the signals divided into blocks by the block division circuitry in units of the period; and determination circuitry configured to determine that the object is in a stationary state in a case where the time correlation calculated by the time correlation calculation circuitry is equal to or greater than a predetermined threshold value.

### TECHNICAL FIELD

The present invention relates to a state detection system, a detection device, a state detection method, and a state detection program.

### BACKGROUND ART

Conventionally, a sensing technology for detecting an object by using channel state information (CSI) of a wireless LAN has been studied.

For example, Patent Literature 1 discloses an object detection system capable of detecting a moving direction of an object even in an environment in which there are many changes in a radio propagation environment other than the detection target and there are few multipaths.

### CITATION LIST

### Patent Literature

Patent Literature 1: JP 2022-20515 A

### SUMMARY OF INVENTION

### Technical Problem

However, in a case where an object is detected by use of CSI, detection accuracy largely depends on an arrangement of antennas and a surrounding propagation environment. Therefore, a system design considering the influence of radio wave propagation characteristics on the object detection accuracy is required.

In addition, conventionally, there is also a problem that prior learning for performing detection is required when an object is detected by use of CSI.

The present invention has been made in view of the above-described problems, and an object of the present invention is to provide a state detection system, a detection device, a state detection method, and a state detection program capable of accurately detecting a state of an object even if learning is not performed in advance.

### Solution to Problem

A state detection system according to one embodiment of the present invention is a state detection system including: a transmission device that transmits a predetermined signal; and a detection device that detects a state of an object on a propagation path of the signal transmitted by the transmission device, wherein the detection device includes: a reception unit that receives, via the propagation path, signals of a same sequence repeatedly transmitted at a predetermined period by the transmission device; a block division unit that divides the signals received by the reception unit into blocks in units of the period; a time correlation calculation unit that calculates a time correlation between the signals divided into blocks by the block division unit in units of the period; and a determination unit that determines that the object is in a stationary state in a case where the time correlation calculated by the time correlation calculation unit is equal to or greater than a predetermined threshold value.

In addition, a detection device according to one embodiment of the present invention includes: a reception unit that receives signals of a same sequence repeatedly transmitted at a predetermined period by a transmission device via a propagation path of the signals transmitted by the transmission device; a block division unit that divides the signals received by the reception unit into blocks in units of the period; a time correlation calculation unit that calculates a time correlation between the signals divided into blocks by the block division unit in units of the period; and a determination unit that determines that an object on the propagation path is in a stationary state in a case where the time correlation calculated by the time correlation calculation unit is equal to or greater than a predetermined threshold value.

In addition, a state detection method according to one embodiment of the present invention is a state detection method for detecting a state of an object on a propagation path of a signal transmitted by a transmission device that transmits a predetermined signal, the state detection method including: a reception step of receiving, via the propagation path, signals of a same sequence repeatedly transmitted at a predetermined period by the transmission device; a block division step of dividing the signals received in the reception step into blocks in units of the period; a time correlation calculation step of calculating a time correlation between the signals divided into blocks in the block division step in units of the period; and a determination step of determining that the object is in a stationary state in a case where the time correlation calculated in the time correlation calculation step is equal to or greater than a predetermined threshold value.

### Advantageous Effects of Invention

According to the present invention, it is possible to accurately detect a state of an object even if learning is not performed in advance.

### BRIEF DESCRIPTION OF DRAWINGS

FIG. 1 is a diagram illustrating an outline of a state detection system according to one embodiment.

FIG. 2 is a functional block diagram illustrating functions of a detection device according to the one embodiment.

FIG. 3(a) is a diagram illustrating signals of the same sequence repeatedly transmitted by a transmission device. FIG. 3(b) is a diagram illustrating signals divided into blocks by a block division unit of the detection device. FIG. 3(c) is a diagram schematically illustrating time correlations calculated by a time correlation calculation unit.

FIG. 4 is a diagram illustrating an exemplary hardware configuration of the detection device according to the one embodiment.

FIG. 5(a) is a diagram schematically illustrating a result of detection by the state detection system, which indicates that a person in a house is in a moving state.

FIG. 5(b) is a diagram schematically illustrating a result of detection by the state detection system, which indicates that a person in the house is in a stationary state.

### DESCRIPTION OF EMBODIMENTS

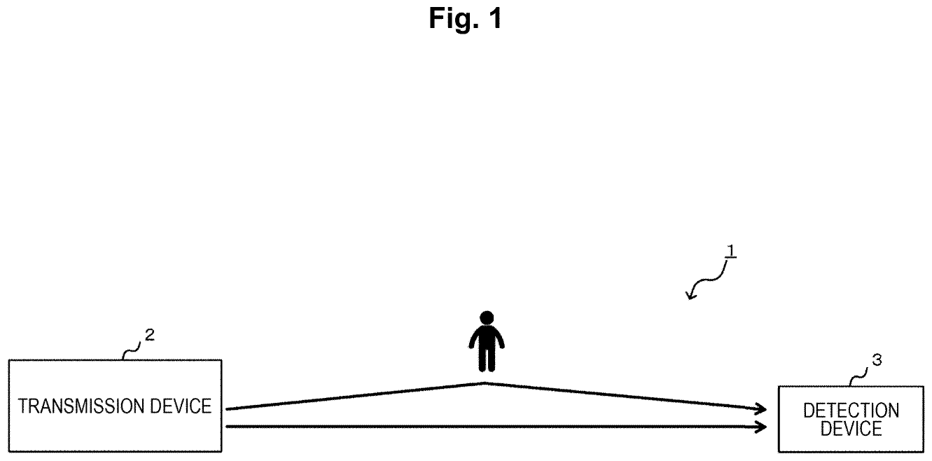

Hereinafter, a state detection system 1 according to one embodiment will be described with reference to the drawings. FIG. 1 is a diagram illustrating an outline of the state detection system 1 according to the one embodiment.

As illustrated in FIG. 1, the state detection system 1 according to the one embodiment includes, for example, a transmission device 2 that transmits a predetermined signal and a detection device 3 that detects a state of an object on a propagation path of the signal transmitted by the transmission device 2.

The transmission device 2 is a communication device used for, for example, local 5G, Wi-Fi (registered trademark), Bluetooth (registered trademark), and other wireless systems, and the type and frequency of the system may be any type and frequency.

The detection device 3 has a function of receiving a radio wave transmitted by the transmission device 2, and may be, for example, a soft wireless device having a function of observing a waveform of a received radio wave, a function of analyzing an observed waveform, and the like.

Here, objects whose states are detected by the state detection system 1 include a person and the like. The state detection system 1 is configured to be able to detect whether a person is in a moving state (moving state) or a person is in a stationary state (stationary state).

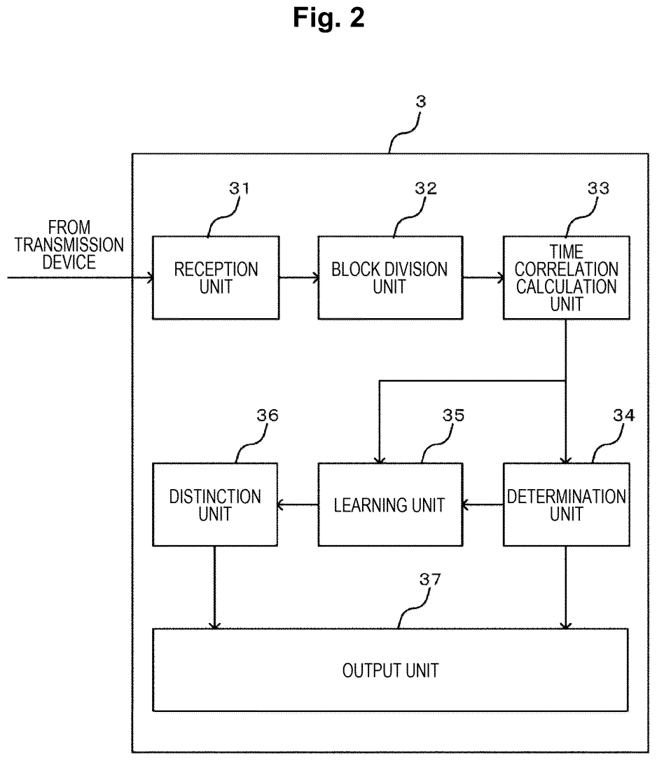

Next, a specific example of the functions of the detection device 3 will be described. FIG. 2 is a functional block diagram illustrating the functions of the detection device 3 according to the one embodiment. As illustrated in FIG. 2, the detection device 3 includes, for example, a reception unit 31, a block division unit 32, a time correlation calculation unit 33, a determination unit 34, a learning unit 35, a distinction unit 36, and an output unit 37.

The reception unit 31 receives signals of the same sequence repeatedly transmitted at a predetermined period T by the transmission device 2 via a propagation path of the signals transmitted by the transmission device 2, and outputs the signals to the block division unit 32. Note that the period T is set to be longer than the maximum delay wavelength in the propagation path of the signals transmitted by the transmission device 2. In addition, the signal sequence of the signals transmitted by the transmission device 2 may be unknown as long as the repetition period T is known.

The block division unit 32 divides the signals received by the reception unit 31 into blocks in units of the period T, and outputs the signals to the time correlation calculation unit 33. For example, the block division unit 32 may divide the signals received by the reception unit 31 into blocks each having a length of the period T, or may divide the signals received by the reception unit 31 into blocks each having a length of an integral multiple of the period T. That is, the block division unit 32 may collectively divide signals of a plurality of sequences into blocks.

The time correlation calculation unit 33 calculates a time correlation between the signals divided into blocks by the block division unit 32 in units of the period T, and outputs the calculated time correlation to the determination unit 34 and the learning unit 35.

The determination unit 34 determines that an object on the propagation path of the signals transmitted by the transmission device 2 is in the stationary state in a case where the time correlation calculated by the time correlation calculation unit 33 is equal to or greater than a predetermined threshold value a. In addition, the determination unit 34 determines that the object on the propagation path of the signals transmitted by the transmission device 2 is in the moving state in a case where the time correlation calculated by the time correlation calculation unit 33 is smaller than the predetermined threshold value a. The determination unit 34 then outputs a result of the determination to the learning unit 35 and the output unit 37.

The learning unit 35 learns the variation amount of the time correlation calculated by the time correlation calculation unit 33 and outputs a result of the learning to the distinction unit 36.

The distinction unit 36 distinguishes whether a change in the state of the object on the propagation path of the signals transmitted by the transmission device 2 or a change in the environment on the propagation path has occurred on the basis of the variation amount learned by the learning unit 35, and outputs a result of the distinction to the output unit 37.

The output unit 37 is, for example, an alarm, a display, or the like that outputs sound or an image, and outputs the result of the determination by the determination unit 34, the result of the distinction by the distinction unit 36, and the like by sound, an image, or the like. Furthermore, the output unit 37 may be configured to output the result of the determination by the determination unit 34, the result of the distinction by the distinction unit 36, and the like by transmission through communication.

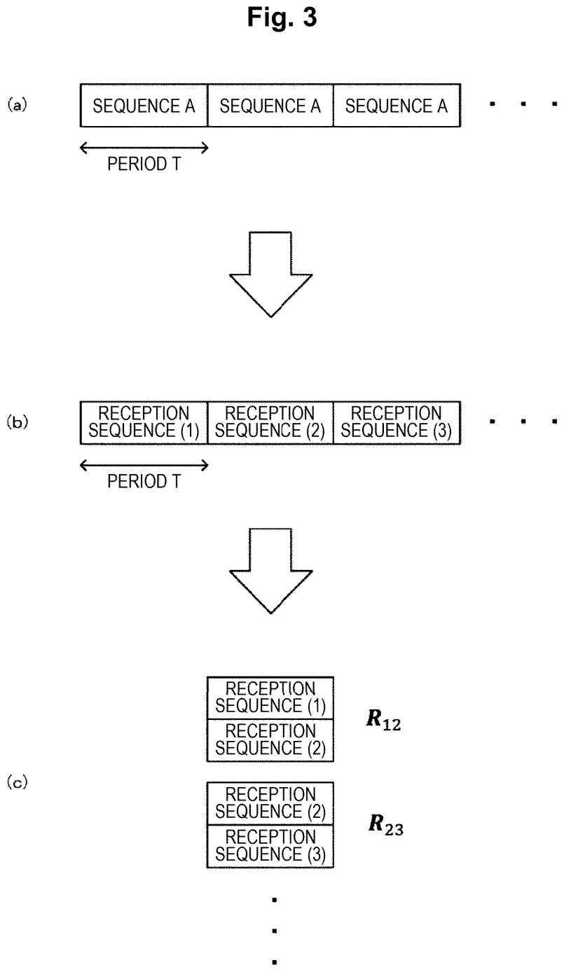

Next, exemplary processing executed by the state detection system 1 will be described. FIG. 3 is a diagram illustrating signals in each step of processing executed by the state detection system 1. FIG. 3(a) is a diagram illustrating signals of the same sequence (sequence A) repeatedly transmitted by the transmission device 2. FIG. 3(b) is a diagram illustrating signals divided into blocks by the block division unit 32 of the detection device 3. FIG. 3(c) is a diagram schematically illustrating time correlations calculated by the time correlation calculation unit 33.

As illustrated in FIG. 3(a), the transmission device 2 repeatedly transmits signals of the same sequence (sequence A). At this time, the period T of the sequence A is set to be longer than the maximum delay wave assumed in the environment in which the state detection system 1 is used.

As illustrated in FIG. 3(b), the block division unit 32 of the detection device 3 divides the reception sequences received by the reception unit 31 into blocks in units of the period T. For example, the block division unit 32 divides a reception sequence (1), a reception sequence (2), a reception sequence (3) and the like, each of which has the period T, into blocks.

As illustrated in FIG. 3(c), the time correlation calculation unit 33 repeatedly calculates a time correlation from a correlation between a block and a previous block. For example, the time correlation calculation unit 33 calculates a time correlation R₁₂ between the reception sequence (1) and the reception sequence (2), a time correlation R₂₃ between the reception sequence (2) and the reception sequence (3), and the like.

When the time correlation calculated by the time correlation calculation unit 33 is equal to or greater than the predetermined threshold value a (for example, R₁₂≥α), the determination unit 34 determines that an object on the propagation path of the signals transmitted by the transmission device 2 is in the stationary state. In addition, when the time correlation calculated by the time correlation calculation unit 33 is smaller than the predetermined threshold value a (for example, R₁₂≤α), the determination unit 34 determines that the object on the propagation path of the signals transmitted by the transmission device 2 is in the moving state.

Note that the state detection system 1 may be configured to calculate a time correlation by extracting a known signal (for example, a control signal such as a synchronization signal or a channel estimation signal) inserted into a part of a general radio frame transmitted by the transmission device 2.

As described above, the state detection system 1 according to the one embodiment calculates a time correlation between signals divided into blocks by the block division unit 32 in units of the period T, and determines that an object on a propagation path of the signals transmitted by the transmission device 2 is in a stationary state in a case where the calculated time correlation is equal to or greater than a predetermined threshold value, so that it is possible to accurately detect a state of the object even if learning is not performed in advance.

Note that some or all of the functions of the transmission device 2 and the detection device 3 may be configured by hardware such as a programmable logic device (PLD) or a field programmable gate array (FPGA), or may be configured as a program executed by a processor such as a CPU.

For example, the detection device 3 can be implemented with a computer and a program, and the program can be recorded in a storage medium or provided through a network.

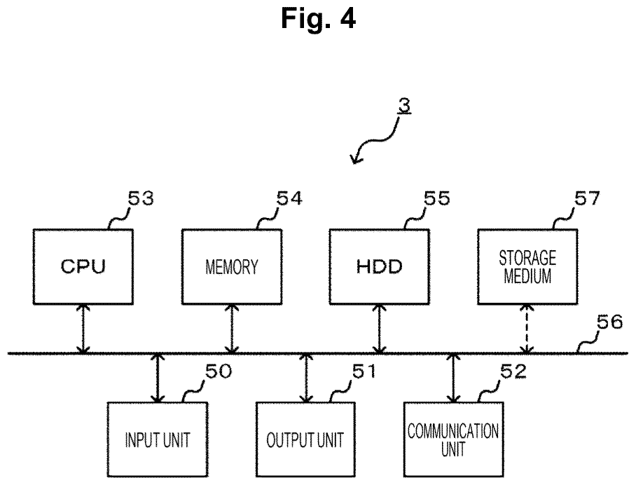

FIG. 4 is a diagram illustrating an exemplary hardware configuration of the detection device 3 according to the one embodiment. As illustrated in FIG. 4, the detection device 3 has a function as a computer in which an input unit 50, an output unit 51, a communication unit 52, a CPU 53, a memory 54, and an HDD 55 are connected via a bus 56. In addition, the detection device 3 can input and output data to and from a computer-readable storage medium 57.

The input unit 50 is, for example, a keyboard and a mouse or the like. The output unit 51 is, for example, a display device such as an alarm or a display corresponding to the output unit 37 described above. The communication unit 52 is a communication interface that performs wireless communication by, for example, a wireless LAN.

The CPU 53 controls each unit included in the detection device 3 and performs predetermined processing and the like. The memory 54 and the HDD 55 are storage units that store data and the like.

The storage medium 57 can store programs and the like for executing the functions of the detection device 3. Note that the architecture that configures the detection device 3 is not limited to the example illustrated in FIG. 4.

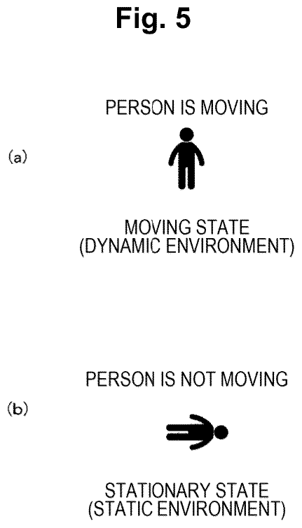

Next, a practical example of the state detection system 1 will be described. FIG. 5 is a diagram illustrating detection results obtained in a case where the state detection system 1 is installed in a house in which an elderly person or the like lives. FIG. 5(a) is a diagram schematically illustrating a result of detection by the state detection system 1, which indicates that a person in the house is in the moving state. FIG. 5(b) is a diagram schematically illustrating a result of detection by the state detection system 1, which indicates that a person in the house is in the stationary state.

In recent years, there have been social problems of the discrimination against the elderly and the like in which a lessor does not lease a house to a single household person such as an elderly person due to concerns about the solitary death or the like of the elderly person.

For example, in a case where the state detection system 1 is installed in a closed space (static fading environment) such as a house in which an elderly person or the like lives, it is possible to detect a state in which the person or the like is moving (dynamic environment) and a state in which the person or the like is stationary (static environment). For example, in a case where the person in the house continues the stationary state for a long time (in a case where the person stops moving), a propagation state of radio waves is different from that in a case where the person moves, and thus the state detection system 1 detects the state in which the person stops moving, and issues an alarm.

### REFERENCE SIGNS LIST

1 State detection system
2 Transmission device
3 Detection device
31 Reception unit
32 Block division unit
33 Time correlation calculation unit
34 Determination unit
35 Learning unit
36 Distinction unit
37 Output unit
50 Input unit
51 Output unit
52 Communication unit
53 CPU
54 Memory
55 HDD
56 Bus
57 Storage medium

1. A state detection system comprising: a transmission device that transmits a predetermined signal; and a detection device that detects a state of an object on a propagation path of the signal transmitted by the transmission device, wherein
the detection device includes:
a receiver to receive, via the propagation path, signals of a same sequence repeatedly transmitted at a predetermined period by the transmission device;
block division circuitry configured to divide the signals received by the receiver into blocks in units of the period;
time correlation calculation circuitry configured to calculate a time correlation between the signals divided into blocks by the block division circuitry in units of the period; and
determination circuitry configured to determine that the object is in a stationary state in a case where the time correlation calculated by the time correlation calculation circuitry is equal to or greater than a predetermined threshold value.

2. The state detection system according to claim 1, wherein
the period
is longer than a maximum delay wavelength in the propagation path.

3. The state detection system according to claim 1, further comprising:
learning circuitry configured to learn a variation amount of the time correlation calculated by the time correlation calculation circuitry; and
distinction circuitry configured to distinguish between a change in the state of the object and a change in an environment on the propagation path on a basis of the variation amount learned by the learning circuitry.

4. A detection device comprising:
a receiver to receive signals of a same sequence repeatedly transmitted at a predetermined period by a transmission device via a propagation path of the signals transmitted by the transmission device;
block division circuitry configured to divide the signals received by the receiver into blocks in units of the period;
time correlation calculation circuitry configured to calculate a time correlation between the signals divided into blocks by the block division circuitry in units of the period; and
determination circuitry configured to determine that an object on the propagation path is in a stationary state in a case where the time correlation calculated by the time correlation calculation circuitry is equal to or greater than a predetermined threshold value.

5. The detection device according to claim 4, wherein
the period
is longer than a maximum delay wavelength in the propagation path.

6. The detection device according to claim 4, further comprising:
learning circuitry configured to learn a variation amount of the time correlation calculated by the time correlation calculation circuitry; and
distinction circuitry configured to distinguish between a change in the state of the object and a change in an environment on the propagation path on a basis of the variation amount learned by the learning circuitry.

7. A state detection method for detecting a state of an object on a propagation path of a signal transmitted by a transmission device that transmits a predetermined signal, the state detection method comprising:
receiving, via the propagation path, signals of a same sequence repeatedly transmitted at a predetermined period by the transmission device;
dividing the signals received in receiving into blocks in units of the period;
calculating a time correlation between the signals divided into blocks in dividing in units of the period; and
determining that the object is in a stationary state in a case where the time correlation calculated in calculating is equal to or greater than a predetermined threshold value.

8. A non-transitory computer-readable storage medium storing a state detection program for causing a computer to function as each circuitry of the detection device according to claim 4.
